(19) United States
(12) Patent Application Publication
(10) Pub. No.: US 2015/0260207 A1
(43) Pub. Date: Sep. 17, 2015

(54) ELASTIC CLIP

(71) Applicant: MARY LOUISA LIGON, ALMONT, MI (US)

(72) Inventor: MARY LOUISA LIGON, ALMONT, MI (US)

(21) Appl. No.: 14/205,528

(22) Filed: Mar. 12, 2014

(51) Int. Cl. F16B 2/14; F16B 7/04

(52) U.S. Cl. CPC F16B 2/14; F16B 7/0433; F16B 7/0493

(57) ABSTRACT

An elastic clip that is functional, inexpensive to produce, requires no tools to use, and allows the user many options on how to use it. It can be used as an adjustable clip with a single elongated member and a keeper. It can be used to fasten together parallel parts with the use of a keeper. Finally, it can fasten together perpendicular members with the perpendicular member parallel to the bend in the nose taking the place of the keeper. Pinching the two handles together allows the user to insert the desired components into the elastic clip and releasing the two handles causes the handles to spring apart forcing the edges of the orifice to apply pressure to the elongated member pushing all the components toward the nose locking everything into an assembled relation.

### FIELD OF THE INVENTION

The present invention relates to elastic clips and more particularly to one which can be inserted anywhere on the body of an elongated member even if the endpoints are not accessible.

### BACKGROUND OF THE INVENTION

There are an ever increasing number of people wanting to take up gardening for personal enjoyment as well as for their health and well-being. Unfortunately many families have been away from gardening and agriculture for many generations and do not have the skills or knowledge to prepare their own gardens in a traditional way. Hay bale gardening has been developed as a new method of gardening that is easy to teach, requires few tools if any, and is very low maintenance with almost no weeding required. As part of my project to promote hay bale gardening I needed to come up with a trellis system that requires little skill to construct, is inexpensive, is portable, requires no tools, uses readily available materials, and is strong enough to support the vines and produce which come out of a healthy gardening system. It should be able to be built, expanded, and taken apart by one person easily and quickly. It should be able to be constructed in a variety of ways limited only by the creativity of the builder.

One embodiment of such a trellis is a low tunnel with additional horizontal members added to the structure. A low tunnel is a very small greenhouse or hoop house which consists of a number of hoops joined by horizontal members. The low tunnel frame is normally covered by various fabrics or plastics and is used to extend the growing season. The structure can vary in size but if built for portability purposes it should be small enough to be carried. In the embodiment presented the hoops and horizontal members are made out of sections of rigid conduit or Polyvinyl Chloride (PVC) pipe, both of which are readily available at any hardware center. This trellis can be covered with insulating material early in the spring season to protect the young plants growing in the hay bales from the cold, and more horizontal members can be added later in the season to be used as a trellis to support the growing plants. This structure is self-standing so no additional supports are needed unless the user is in a windy area and wishes to place hay bales on the bottom of the structure to weigh it down. The structure can be taken down in the winter or covered in plastic or canvas to provide shelter from the weather. There are many such structures on the market, but they all require tools and expensive parts for the connections between the horizontal pieces and the hoops. The challenge was to find a tool-free inexpensive fastener or coupler that could be used repeatedly. This fastener should be adjustable and should accommodate perpendicular members, parallel members, single and multiple members, and members of all shapes and sizes.

There are many ways to fasten elongated members together. One can weld them, bolt them, wire tie them, tape them or even fabricate special metal stampings to the shape of the elongated members and affix them with nuts and bolts. An example of using metal stampings to build a trellis is an invention by A. E. VAIL for the TRELLIS STRUCTURE in U.S. Pat. No. 3,157,001 issued Nov. 17, 1964. Such methods and assemblies require tools and skill to construct, are cumbersome, and are not easy to disassemble.

The most useful fastening method that I found for my project was a simple spring clip type fastener. These fasteners have a long history and their use is well known by those skilled in the art. They all have arms or handles that can be manually pinched together and each handle has a hole that can accommodate elongated members of the proper size. Spring clips can be used as adjustable supports such as the U.S. Pat. No. 1,505,220 issued on Aug. 19, 1924 to R. R. SHAY for SPRING CLAMP. They can be used to hold parallel overlapping members together as shown by the U.S. Pat. No. 2,476,427 issued on Jul. 19, 1949 to F. F. MELVIN ET AL for OVERLAPPING WIRE ENGAGING DEVICE. Finally, spring clips can be used to hold perpendicular members together such as the U.S. Pat. No. 6,484,330 B2 issued Apr. 2, 2013 to GREY ET AL for COUPLING FOR A FAUCET LIFT ROD and the U.S. Pat. No. 8,407,829 B2 issued Apr. 2, 2013 to VOGEL for COUPLING FOR A FAUCET LIFT ROD.

The prior art teaches that the existing fasteners can be manufactured to meet all my requirements except one. In every case access to an endpoint of the elongated member is required. If additional horizontal members were added in the trellis system the spring clips described in the prior art would require disassembly and reassembly of certain parts of the trellis.

The present invention allows entry of the elongated member into the elastic clip at any point on the body or ends of the elongated member. It would be advantageous to provide an elastic clip that can be used on projects where the end points of the elongated member are not accessible. It would also be advantageous to provide an elastic clip that is adjustable, that can fasten together both parallel and perpendicular parts, and that is universal in nature. It would further be advantageous to provide an elastic clip that does not require tools to use.

### SUMMARY OF THE INVENTION

In accordance with the present invention, there is provided an elastic clip that is functional, tool free, inexpensive to produce, and can be used in a great variety of applications. It can be used on elongated members where no end point can be accessed. It can function as an adjustable clip as well as a universal fastener for both parallel and perpendicular elongated members. Pinching the two handles together allows the user to insert the desired components into the elastic clip, and releasing the two handles causes them to spring apart which locks everything into an assembled relation.

### BRIEF DESCRIPTION OF THE DRAWINGS

A complete understanding of the present invention may be obtained by reference to the accompanying drawings, when considered in conjunction with the detailed description, in which:

FIG. 1a is a perspective view of the elastic clip in accordance with the invention that is bent or formed prior to assembly.

FIG. 1b is a perspective view of the elastic clip that will be bent or formed by the user during assembly.

FIG. 2 is a perspective view of the elastic clip showing the accommodation of the elongated member and the keeper in accordance with the invention.

FIG. 3a is a perspective view of a method of assembly showing the elongated member inserted first.

FIG. 3b is a perspective view of an alternative method of assembly showing the keeper inserted first.

FIG. 4a is a perspective view of the base structure for a hoop style trellis system.

FIG. 4b is a perspective view of a close up of one of the hoops from FIG. 4a.

FIG. 4c is a perspective view of a close up of the lower right elastic clip assembly from FIG. 4b.

FIG. 5 is a perspective view of a generic prior art spring clip.

For purposes of clarity and brevity, like elements and components will bear the same designations and numbering throughout the figures.

### DESCRIPTION OF THE PREFERRED EMBODIMENT

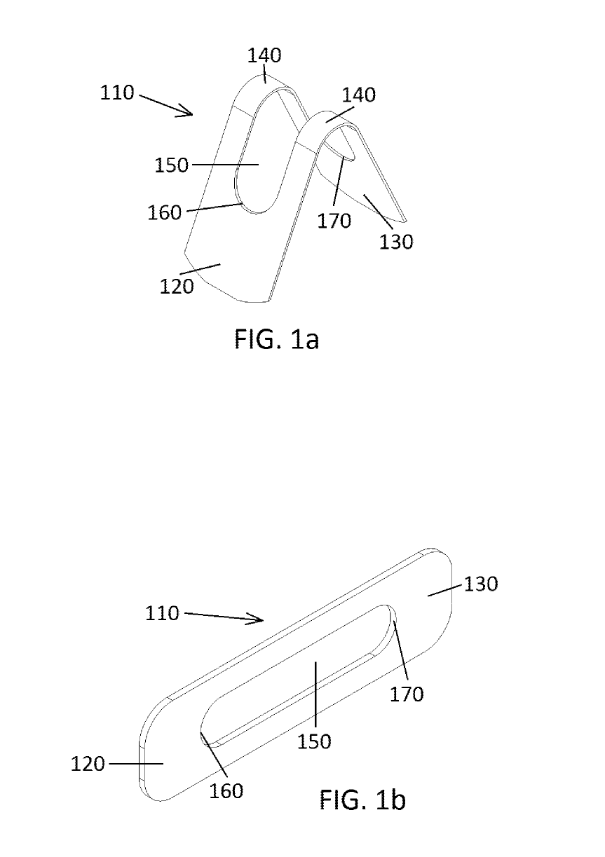

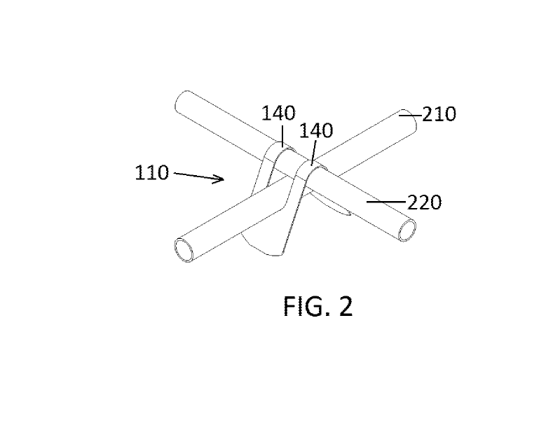

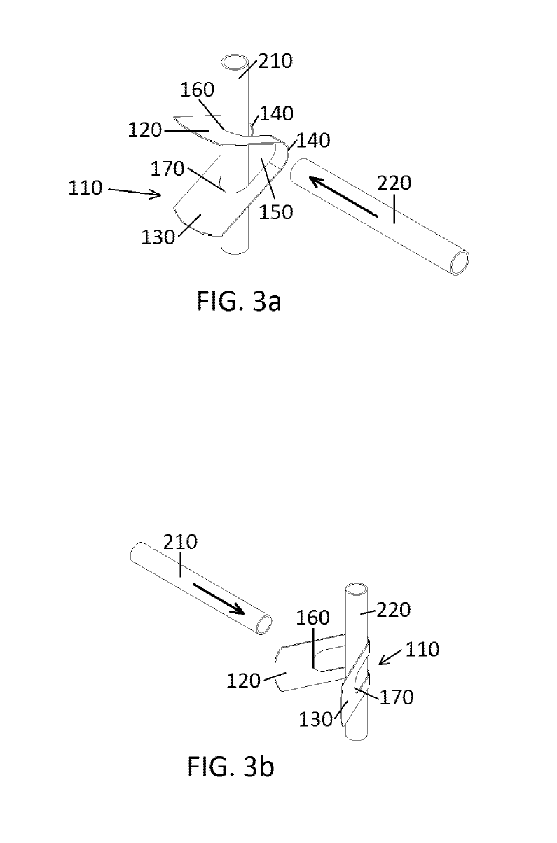

FIG. 1a is a perspective view of the elastic clip 110 in accordance with the invention that is bent or formed prior to assembly. The elastic clip 110 is fabricated of a single piece of resilient material such as spring steel of suitable gauge, metals, polymers, plastics, rubbers, woods or any other resilient material which suits the purpose. The elastic clip 110 is comprised of a nose 140 which is formed in accordance with the invention leaving a first handle 120 and a second handle 130 on the free ends of the form. Whatever form the nose 140 takes it should be formed such that the first handle 120 and the second handle 130 are spring biased in outwardly opposite directions corresponding to the longitudinal axial direction of the elongated member 210 as shown in FIG. 2. The bend or forming can occur prior to assembly by the manufacturer as shown in FIG. 1a or at the time of assembly by the user as shown in FIG. 1b. The orifice 150 completely splits the nose 140 which allows entry of the elongated member 210, as shown in FIG. 3a, into the elastic clip 110 at any point on the body of the elongated member 210 as shown in FIG. 3a. The orifice 150 is of proper size and shape to accommodate the entry of the elongated member 210, as shown in FIG. 3a, into the elastic clip 110. The orifice 150 has one uninterrupted perimeter. On the perimeter of the orifice 150 in the approximate portions most distal from the nose 140 are the first edge 160 and the second edge 170. The first edge 160 and second edge 170 are defined as the portions of the perimeter of the orifice 150 which contacts the elongated member 210, as shown in FIG. 3a and FIG. 3b, when the elastic clip 110 is in use.

FIG. 1b is a perspective view of the elastic clip 110 that will be bent or formed by the user during assembly. The nose 140, which is pictured in FIG. 1a, is not formed in this embodiment of the invention until a later time, thus it cannot be labeled in this drawing. There are many reasons that a manufacturer might not wish to form the nose 140, as shown in FIG. 1a, at the manufacturing stage. These include the ability of the resilient material to hold a shape, manufacturing costs, shipping costs, storage costs, unknown applications, and physical attributes of the resilient material. This list is not to be considered exhaustive.

The elastic clip 110 is fabricated of a single piece of resilient material such as spring steel of suitable gauge, metals, polymers, plastics, rubbers, woods or any other resilient material which suits the purpose. The elastic clip 110 in this embodiment is comprised of a first handle 120 and a second handle 130 on the free ends of the elastic clip 110. Between the first handle 120 and the second handle 130 is an orifice 150 which has one uninterrupted perimeter. On the perimeter of the orifice 150 are the first edge 160 and the second edge 170. The exact position and the functions of the first edge 160 and the second edge 170 are explained in detail in the descriptions of FIG. 1a, FIG. 3a and FIG. 3b.

FIG. 2 is a perspective view of the elastic clip 110 showing the accommodation of the elongated member 210 and the keeper 220 in accordance with the invention. The elongated member 210 is inserted inside the elastic clip 110 touching the first edge 160 and the second edge 170, shown in FIG. 1a and the keeper 220 is inserted between the nose 140 and the elongated member 210.

FIG. 3a is a perspective view of a method of assembly showing the elongated member 210 inserted first. This method of assembly does not require access to an endpoint of the elongated member 210. The orifice 150 is the proper shape and size to accommodate the entry of the elongated member 210. The design of the orifice 150 allows the user to apply the elastic clip 110 anywhere along the body of the elongated member 210. This may be important if an endpoint of the elongated member 210 is not easily accessible.

The elongated member 210 is inserted into the elastic clip 110 and then the keeper 220 is inserted into the elastic clip 110. The elastic clip 110 is shown with the elongated member 210 already in place. To insert the keeper 220, the first handle 120 and the second handle 130 are pinched towards each other using fingers or other suitable means. This pinching creates more space between the nose 140 and the elongated member 210, allowing for the insertion of the keeper 220. The arrow pictured on the keeper 220 in FIG. 3a shows a possible direction of insertion. In the pinched position the elongated member 210 and keeper 220 can be moved relative to each other and relative to the elastic clip 110. The elastic clip 110 maintains the perpendicular orientation of the elongated member 210 and the keeper 220. When the desired position is achieved, the elastic clip 110 is released from its pinched position. The spring bias of the first handle 120 and the second handle 130 cause the first edge 160 and the second edge 170 to apply pressure to the elongated member 210, locking the whole assembly into place.

FIG. 3b is a perspective view of an alternative method of assembly showing the keeper 220 inserted first. This method of assembly does not require access to an endpoint of the keeper 220. The keeper 220 is inserted into the elastic clip 110, and then the elongated member 210 is inserted into the elastic clip 110. The elastic clip 110 is shown with the keeper 220 already in place. To insert the elongated member 210, the first handle 120 and the second handle 130 are pinched towards each other using fingers or other suitable means. This pinching creates more space between the first edge 160 and the keeper 220 and the second edge 170 and the keeper 220, allowing for the insertion of the elongated member 210. The arrow on the elongated member 210 in FIG. 3b shows a possible direction of insertion. In the pinched position the elongated member 210 and the keeper 220 can be moved relative to each other and relative to the elastic clip 110. The elastic clip 110 maintains a perpendicular orientation of the elongated member 210 and the keeper 220. When the desired position is achieved the elastic clip 110 is released from its pinched position. The spring bias of the first handle 120 and the second handle 130 cause the first edge 160 and the second edge 170 to apply pressure to the elongated member 210, locking the whole assembly into place.

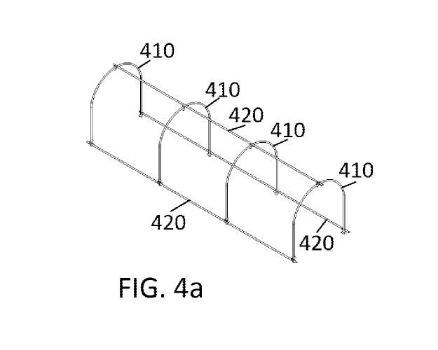

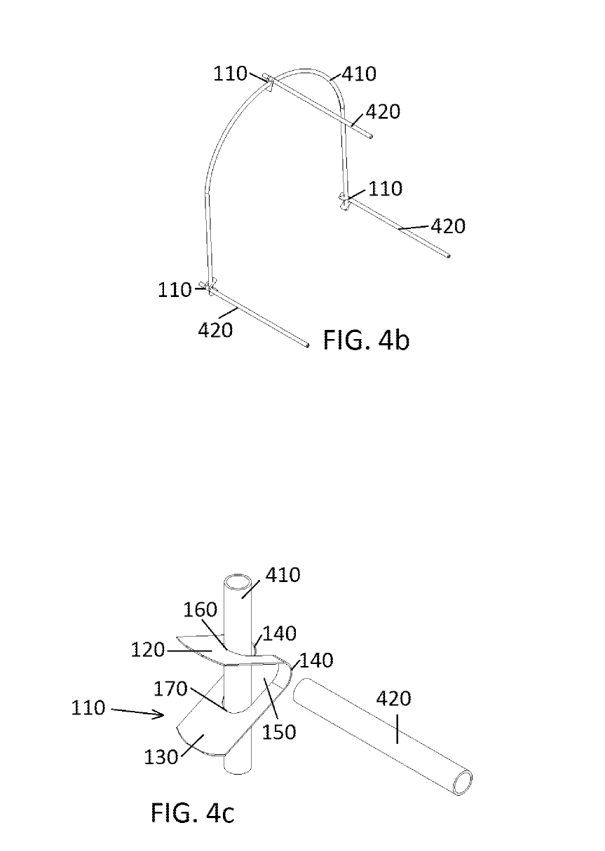

FIG. 4a is a perspective view of the base structure for a hoop style trellis system. Shown in FIG. 4a are a plurality of horizontal elongated members 420 and a series of hoops 410 which form the base structure for a hoop style trellis system that is portable, self-standing and require no tools for assembly. Addition of horizontal elongated members 420 to the base structure will make it useful as a trellis system.

FIG. 4b is a perspective view of a close up of one of the hoops 410 from FIG. 4a. This view shows the orientation of the elastic clips 110, the hoops 410 and the horizontal elongated members 420. The drawing shows the preferred assembly of the base trellis system, although other assemblies are possible.

FIG. 4c is a perspective view of a close up of the lower right elastic clip 110 assembly from FIG. 4b. In this assembly the first handle 120 and the second handle 130 point toward the inside of the base structure. This ensures a smooth structure to which a covering could be applied. FIG. 4c also shows the body of the hoops 410 in contact with the first edge 160 and the second edge 170 of the elastic clip 110. This position inside the elastic clip 110 is advantageous because the first edge 160 and the second edge 170 of the elastic clip 110 will bite into the bodies of the hoops 410, which will prevent the assembly from slipping in a downward direction when weight from the vines is applied to any member of the assembly. Finally, the horizontal elongated members 420 are slipped into position near the nose 140 of the elastic clip 110.

The preferred method of assembly is to insert the elastic clip 110 into position on the hoops 410, then pinch the first handle 120 and the second handle 130 leaving room in the nose 140 to slide the ends of the horizontal elongated members 420 into position. The horizontal elongated members 420 effectively block the orifice 150 at the point where it split the nose 140 and frictionally engage the hoops 410 locking the whole assembly into position.

This method of assembly is described fully in the description of FIG. 3a. The method of assembly described in FIG. 3a is preferred because the ends of the horizontal elongated members 420 are accessible while the ends of the hoops 410 are not easily accessible. Many other methods of assembly are possible and may be desired depending on the circumstances.

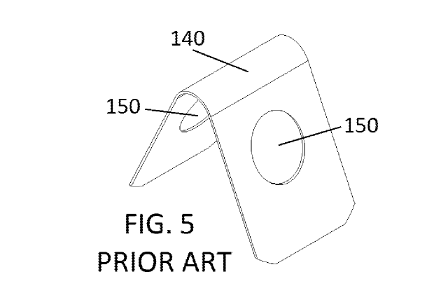

FIG. 5 is a perspective view of the prior art spring clip. One physical difference between the elastic clip 110, as shown in FIG. 1a, and the prior art spring clip, shown in FIG. 5, is that the prior art spring clip has more than one orifice 150 which leaves a fully intact nose 140, while the elastic clip 110 in the present invention has a single orifice 150 which completely splits the nose 140. The prior art can only accept an elongated member 210, as shown in FIG. 2, if it can be inserted using an endpoint.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the appended claims.

What is claimed is:

1. An elastic clip for providing an adjustable fastening system, comprising:
means for manipulating the amount of space between said edges and said nose allowing for assembly, disassembly and adjustments;
means for manipulating the amount of space between said edges and said nose allowing for assembly, disassembly and adjustments;
means for accommodating the keeper which can be bent or formed prior to assembly or at the time of assembly in a shape that holds the first handle and second handle such that they are inherently spring biased in outwardly opposite directions corresponding to the longitudinal axial direction of the elongated member, functionally connected to said means for manipulating the amount of space between said edges and said nose allowing for assembly, disassembly and adjustments and functionally connected to said means for manipulating the amount of space between said edges and said nose allowing for assembly, disassembly and adjustments;
means for providing a point of entry for the elongated member into the elastic clip from any location on the body or the ends of the elongated member, completely bifurcating said means for accommodating the keeper which can be bent or formed prior to assembly or at the time of assembly in a shape that holds the first handle and second handle such that they are inherently spring biased in outwardly opposite directions corresponding to the longitudinal axial direction of the elongated member;
means for providing frictional clamping pressure on the body of elongated member, functionally positioned to said means for providing a point of entry for the elongated member into the elastic clip from any location on the body or the ends of the elongated member;
means for providing frictional clamping pressure on the body of elongated member, diametrically separated to said means for providing frictional clamping pressure on the body of elongated member, and functionally positioned to said means for providing a point of entry for the elongated member into the elastic clip from any location on the body or the ends of the elongated member; and
means for securing said elongated member in desired position, insertably clamped within said means for accommodating the keeper which can be bent or formed prior to assembly or at the time of assembly in a shape that holds the first handle and second handle such that they are inherently spring biased in outwardly opposite directions corresponding to the longitudinal axial direction of the elongated member.

2. The elastic clip in accordance with claim 1, wherein said means for manipulating the amount of space between said edges and said nose allowing for assembly, disassembly and adjustments comprises a resilient first handle.

3. The elastic clip in accordance with claim 1, wherein said means for manipulating the amount of space between said edges and said nose allowing for assembly, disassembly and adjustments comprises a resilient second handle.

4. The elastic clip in accordance with claim 1, wherein said means for accommodating the keeper which can be bent or formed prior to assembly or at the time of assembly in a shape that holds the first handle and second handle such that they are inherently spring biased in outwardly opposite directions corresponding to the longitudinal axial direction of the elongated member comprises an elastic nose.

5. The elastic clip in accordance with claim 1, wherein said means for providing a point of entry for the elongated member into the elastic clip from any location on the body or the ends of the elongated member comprises an orifice.

6. The elastic clip in accordance with claim 1, wherein said means for providing frictional clamping pressure on the body of elongated member comprises a sharp first edge.

7. The elastic clip in accordance with claim 1, wherein said means for providing frictional clamping pressure on the body of elongated member comprises a sharp second edge.

8. The elastic clip in accordance with claim 1, wherein said means for securing said elongated member in desired position perpendicular to the keeper.

9. An elastic clip for providing an adjustable fastening system, comprising:
a resilient first handle, for manipulating the amount of space between the said edges and said nose allowing for assembly, disassembly and adjustments;
a resilient second handle, for manipulating the amount of space between the said edges and said nose allowing for assembly, disassembly and adjustments;
an elastic nose, for accommodating the keeper which can be bent or formed prior to assembly or at the time of assembly in a shape that holds the first handle and second handle such that they are inherently spring biased in outwardly opposite directions corresponding to the longitudinal axial direction of the elongated member, functionally connected to said second handle, and functionally connected to said first handle;
an orifice, for providing a point of entry for the elongated member into the elastic clip from any location on the body or the ends of the elongated member, completely bifurcating said nose;
a sharp first edge, for providing frictional clamping pressure on the body of elongated member, functionally positioned to said orifice;
a sharp second edge, for providing frictional clamping pressure on the body of elongated member, diametrically separated to said first edge, and functionally positioned to said orifice; and
a keeper, for securing said elongated member in desired position, insertably clamped within said nose.

10. The elastic clip as recited in claim 9, wherein said first handle, said second handle and said nose has characteristics selected from the following group: metals, polymers, plastics, rubbers, and woods.

11. The elastic clip as recited in claim 9, wherein said nose has characteristics selected from the following group: formed, V-shaped, flat, and radiused.

12. An elastic clip for providing an adjustable fastening system, comprising:
a metals, polymers, plastics, rubbers, woods, or any other resilient material first handle, for manipulating the amount of space between said edges and said nose allowing for assembly, disassembly and adjustments;
a metals, polymers, plastics, rubbers, woods, or any other resilient material second handle, for manipulating the amount of space between said edges and said nose allowing for assembly, disassembly and adjustments;
an elastic, formed, v-shaped, flat, or radiused nose, for accommodating the keeper which can be bent or formed prior to assembly or at the time of assembly in a shape that holds the first handle and second handle such that they are inherently spring biased in outwardly opposite directions corresponding to the longitudinal axial direction of the elongated member, functionally connected to said second handle, and functionally connected to said first handle;
an orifice, for providing a point of entry for the elongated member into the elastic clip from any location on the body or the ends of the elongated member, completely bifurcating said nose;
a sharp first edge, for providing frictional clamping pressure on the body of elongated member, functionally positioned to said orifice;
a sharp second edge, for providing frictional clamping pressure on the body of elongated member, diametrically separated from said first edge, and functionally positioned to said orifice; and
a keeper, for securing said elongated member in desired position, insertably clamped within said nose.
